(19) United States
(12) Patent Application Publication
(10) Pub. No.: US 2015/0085307 A1
(43) Pub. Date: Mar. 26, 2015

(54) MANAGEMENT SYSTEM, IMAGE FORMING DEVICE, AND TERMINAL DEVICE

(71) Applicant: Kabushiki Kaisha Toshiba, Tokyo (JP)

(72) Inventors: Kaoru Suzuki, Yokohama-shi (JP); Yojiro Tonouchi, Inagi-shi (JP); Kazunori Imoto, Kawasaki-shi (JP); Isao Mihara, Tokyo (JP)

(21) Appl. No.: 14/462,440

(22) Filed: Aug. 18, 2014

(30) Foreign Application Priority Data
Sep. 24, 2013 (JP) 2013-196933

(51) Int. Cl. H04N 1/21; G06F 17/30; G06F 3/12; H04N 1/32

(52) U.S. Cl. CPC H04N 1/2183; H04N 1/32128; G06F 17/30256; G06F 3/1237; H04N 2201/3295; H04N 2201/0094
USPC 358/1.13; 358/1.15

(57) ABSTRACT

According to an embodiment, a management system includes a first storage, a first generator, a second generator, a second storage, and a printer. The first storage is configured to store therein content data. The first generator is configured to acquire the content data and address data where the content data is stored, from the first storage, and generate a drawing command for printing the content data from the content data. The second generator is configured to generate image data of the content data according to the drawing command. The second storage is configured to store therein the address data and tag data based on the image data in association with each other. The printer is configured to generate a printed medium by printing the image data on a medium.

### CROSS-REFERENCE TO RELATED APPLICATION

This application is based upon and claims the benefit of priority from Japanese Patent Application No. 2013-196933, filed on Sep. 24, 2013; the entire contents of which are incorporated herein by reference.

### FIELD

Embodiments described herein relate generally to a management system, an image forming device, and a terminal device.

### BACKGROUND

Conventional image forming devices for printing image data of content data use a known technique that stores content data and image data serving as tag data in association with each other, searches the image data stored in association with the content data based on image data of a printed material where the image data are printed, and accesses the content data.

In such a conventional technique, the content data are stored in printing whereas the tag data are stored by a user asynchronously with the printing. This increases load and cost to the user. In addition, this may cause omission of registration and incorrect construction of data to be managed.

Furthermore, such a conventional technique stores content data themselves. This requires an increase in the memory capacity of a storage and thus increases the cost.

An advantage of some aspects of the embodiments is to provide a management system, an image forming device, and a terminal device that can correctly construct data to be managed with a reduced cost.

### BRIEF DESCRIPTION OF THE DRAWINGS

FIG. 1 is a configuration diagram illustrating an example of a management system according to an embodiment;

FIG. 2 is a flowchart illustrating an example of printing and data construction processing according to the embodiment;

FIG. 3 is a flowchart illustrating an example of search processing according to the embodiment;

FIG. 4 is a flowchart illustrating an example of address data updating processing according to the embodiment;

FIG. 5 is a flowchart illustrating an example of address data replacing processing according to the embodiment;

FIG. 6 is a flowchart illustrating an example of added data extracting processing according to the embodiment;

FIG. 7 is a diagram illustrating an example of a registration setting screen according to the embodiment;

FIG. 8 is a diagram illustrating an example of a setting screen on image or letter according to the embodiment;

FIG. 9 is a diagram illustrating an example of a hardware configuration of a terminal device according to the embodiment and modifications; and

FIG. 10 is a diagram illustrating an example of a hardware configuration of an image forming device according to the embodiment and the modifications.

### DETAILED DESCRIPTION

According to an embodiment, a management system includes a first storage, a first generator, a second generator, a second storage, and a printer. The first storage is configured to store therein content data. The first generator is configured to acquire, the content data and address data where the content data is stored, from the first storage, and generate a drawing command for printing the content data from the content data. The second generator is configured to generate image data of the content data according to the drawing command. The second storage is configured to store therein the address data and tag data based on the image data in association with each other. The printer is configured to generate a printed medium by printing the image data on a medium.

Embodiments will be described in detail with reference to the accompanying drawings.

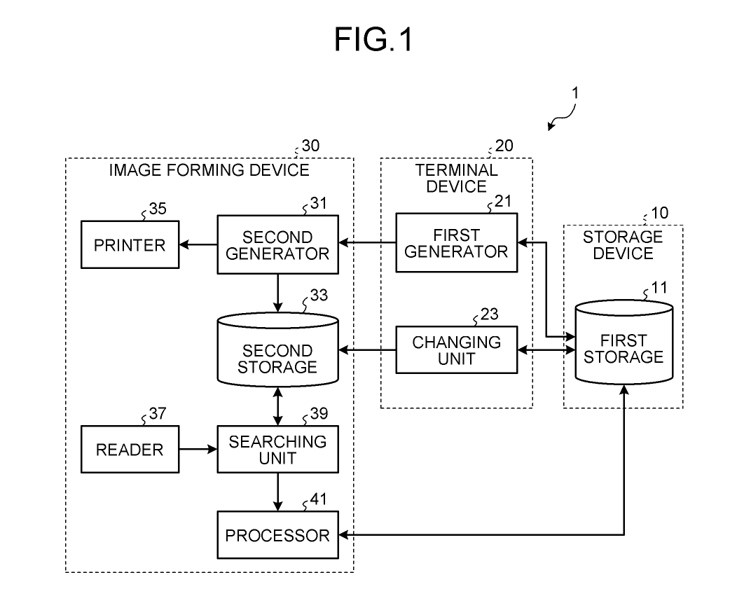

FIG. 1 is a configuration diagram illustrating an example of a management system 1 according to an embodiment. As illustrated in FIG. 1, the management system 1 includes a storage device 10, a terminal device 20, and an image forming device 30. The storage device 10 and the terminal device 20 are connected to each other through a first communication path (not illustrated). The terminal device 20 and the image forming device 30 are connected to each other through a second communication path (not illustrated).

The first communication path is implemented by a network such as a local area network (LAN) and the Internet. The second communication path is implemented with a network such as a LAN and the Internet, a communication cable such as a universal serial bus (USB) cable and a printer cable, and the like.

The storage device 10 is a device for storing content data, whose examples include a database and cloud. The terminal device 20 is a user terminal to which a printer driver of the image forming device 30 is installed. Examples of the terminal device 20 include a personal computer (PC), a smart phone, and a tablet terminal. The image forming device 30 is a device for forming an image on media such as print paper by printing, whose examples include a multifunction peripheral (MFP). The multifunction peripheral has at least one function of a copying function, a scanning function, and a facsimile function in addition to a printing function.

The storage device 10 includes a first storage 11.

The first storage 11 stores therein content data. It is implemented by a storage device capable of magnetically or electrically storing therein data, such as a hard disk drive (HDD) and a solid state drive (SSD).

The terminal device 20 includes a first generator 21 and a changing unit 23. The first generator 21 and the changing unit 23 are implemented with a processing device such as a central processor (CPU) executing a program, in other words, by software.

The first generator 21 acquires, from the first storage 11, content data and address data where the content data is stored, and generates a drawing command for printing the content data from the acquired content data.

For example, the first generator 21 acquires the address data together with the content data from the first storage 11 according to a printing instruction input by a user through an input device (not illustrated) of the terminal device 20, and generates a drawing command.

If the first storage 11 is a file system, examples of the address data may include a file path of the content data. If the storage device 10 is a server on the web, examples of the address data may include a uniform resource locator (URL) of the content data. The drawing command is written, for example, in a page description language (PDL).

The first generator 21 outputs the generated drawing command and the acquired address data to the image forming device 30.

When acquiring the content data from the first storage 11, the first generator 21 sets a monitoring flag indicating that the content is to be monitored on file properties of the content data stored in the first storage 11.

The changing unit 23 will be described later.

The image forming device 30 includes a second generator 31, a second storage 33, a printer 35, a reader 37, a searching unit 39, and a processor 41.

The second generator 31, the searching unit 39, and the processor 41 are implemented with a processing device such as a CPU executing a program, in other words, by software. The second storage 33 is implemented by a storage device capable of magnetically and electrically storing therein data, such as an HDD and SSD. The printer 35 is implemented by a printing device such as a printer and a plotter. The reader 37 is implemented by a reading device such as a scanner.

The second generator 31 generates image data of the content data according to the drawing command output from the first generator 21. The second generator 31 stores tag data based on the generated image data and the address data output from the first generator 21 in the second storage 33 in association with each other. For example, the second generator 31 stores the tag data and the address data as a record in the second storage 33, and manages the record (the tag data and the address data) as a managed object.

The embodiment discloses tag data as image data; however, that is not limiting. Tag data may be hereinafter called image data.

The printer 35 prints the image data generated by the second generator 31 on a medium, and generates a printed medium.

The changing unit 23 of the terminal device 20 is now described.

The changing unit 23 monitors the content data stored in the first storage 11. For example, the changing unit 23 constantly monitors content data with file properties on which a monitoring flag is set by the first generator 21 among the content data stored in the first storage 11.

If any change occurs on the content data as a monitored object, the changing unit 23 changes the address data, being stored in the second storage 33, of the content data according to the change.

In specific, if the change on the content data is renaming, which changes a name of the content data, or a transfer, which changes the area where the content data is stored in the first storage 11, the changing unit 23 acquires, from the first storage 11, address data where the content data is stored after the renaming or the transfer, and changes (updates) the address data, being stored in the second storage 33, of the content data to the acquired address data.

The changing unit 23 monitors the operation of a user on the content data stored in the first storage 11 as a monitored object. When detecting a renaming or transferring operation, the changing unit 23 acquires address data before the renaming or transferring operation and address data after the renaming or transferring operation from the first storage 11.

The changing unit 23 outputs an address updating command including the address data before the renaming or transferring operation and the address data after the renaming or transferring operation to the second storage 33, and updates address data of the content data as a monitored object, the address data coinciding with the address data before the renaming or transferring operation and stored in the second storage 33, to the address data after the renaming or transferring operation.

If the change on the content data is a deletion of the content data, the changing unit 23 acquires the content data from the first storage 11 before the deletion and changes/replaces address data, being stored in the second storage 33, of the content data to/with the content data.

More specifically, the changing unit 23 monitors the operation of a user on the content data stored in the first storage 11 as a monitored object. When detecting a deleting operation, the changing unit 23 acquires address data before the deleting operation and the content data as a monitored object from the first storage 11.

The changing unit 23 outputs an address replacing command including the address data before the deleting operation and the content data to the second storage 33, and replaces address data of the content data as a monitored object, the address data coinciding with the address data before the deleting operation and stored in the second storage 33, with the content data.

The image forming device 30 is now further described.

The reader 37 electrically reads a printed medium generated by the printer 35 and generates media image data. More specifically, the reader 37 reads a printed medium according to a searching instruction input by a user through an input device (not illustrated) of the image forming device 30, and generates the media image data.

The searching unit 39 searches the second storage 33 for image data (tag data) in which the degree of similarity with query data based on the media image data generated by the reader 37 is equal to or greater than a threshold, and acquires address data associated with the image data (tag data).

The embodiment discloses query data as media image data; however, that is not limiting. Query data may be hereinafter called media image data.

The searching unit 39 extracts a certain image feature point from each of the media image data (query data) and the image data (tag data). In specific, the searching unit 39 extracts an image feature point from each image using algorithms such as the scale-invariant feature transform (SIFT), the speed-up robust features (SURF), and the fast retina keypoint (FREAK).

The searching unit 39 extracts a set of image feature points in which the degree of similarity between them is equal to or greater than a first threshold. Setting the number of sets of the extracted image feature points as the degree of similarity between the images, the searching unit 39 searches image data (tag data) in which the degree of similarity is equal to or greater than a second threshold and the highest.

The processor 41 performs processing based on the address data acquired by the searching unit 39. The processor 41 performs processing based on the address data acquired by the searching unit 39, the media image data (query data) generated by the reader 37, and the image data (tag data) retrieved by the searching unit 39.

The content data may be application data such as document data generated by a document editing program, spreadsheet data generated by a spreadsheet program, and image data generated by an image editing program. The printed medium may be a printed material of the application data. The printed material may be used as a conference material on which a variety of writing such as a memo is written by attendees at the conference.

In this case, the processor 41 extracts additional data in the media image data (specifically, additional data added to the content data) from the media image data based on the image data retrieved by the searching unit 39.

Specifically, the processor 41 evaluates the difference in images between the media image data and the image data, and extracts a certain group of pixels that is not found on the image data but found on the media image data as the additional data. The processor 41 detects the difference in images between both image data by transforming the coordinates of the media image data so that an image feature point on the media image data comes to the same position as the corresponding image feature point on the image data. The homography transformation may be applied for the coordinate transformation.

The processor 41 may store the additional data in the first storage 11 in association with the content data using the address data. This enables management of not only the content data but what is added thereto as a memo.

The processor 41 may acquire the content data from the first storage 11 using the address data, and output the content data and the additional data. Furthermore, the processor 41 may output the content data and the additional data on a display device (not illustrated) or the like of the terminal device 20. This enables a user to recognize what is added as a memo and determine whether any falsification is made.

In another way, the processor 41 may acquire the content data from the first storage 11 using the address data, generate additional content data by adding the additional data to the acquired content data, and store the additional content data in the first storage 11. This also enables management of not only the content data but what is added thereto as a memo.

At this time, version management of the content data is achieved by making the changing unit 23 store address data of the additional content data in a manner of associating the address data with the address data of the content data stored in the first storage 11.

The processor 41 may acquire the content data from the first storage 11 using the address data, generate the additional content data by adding the additional data to the acquired content data, and output the additional content data. The processor 41 may output the additional content data on a display device (not illustrated) or the like of the terminal device 20. This also enables a user to recognize what is added as a memo and determine whether any falsification is made.

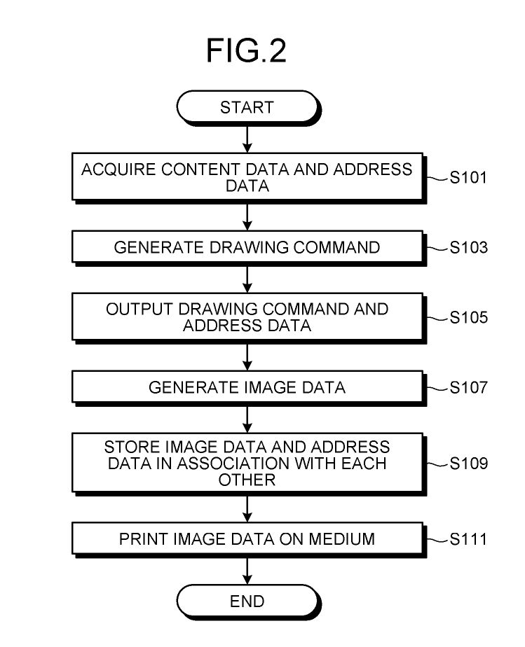

FIG. 2 is a flowchart illustrating an example of the procedure flow of printing and data construction processing implemented by the management system 1 according to the embodiment.

The first generator 21 acquires content data and address data from the first storage 11 according to a printing instruction input by a user through an input device (not illustrated) of the terminal device 20 (Step S101), generates a drawing command (Step S103), and outputs the generated drawing command and the acquired address data to the image forming device 30 (Step S105).

The second generator 31 generates image data of the content data according to the drawing command output from the first generator 21 (Step S107), and stores the image data and the address data output from the first generator 21 in the second storage 33 in association with each other (Step S109).

The printer 35 prints the image data generated by the second generator 31 on a medium, and generates a printed medium (Step S111).

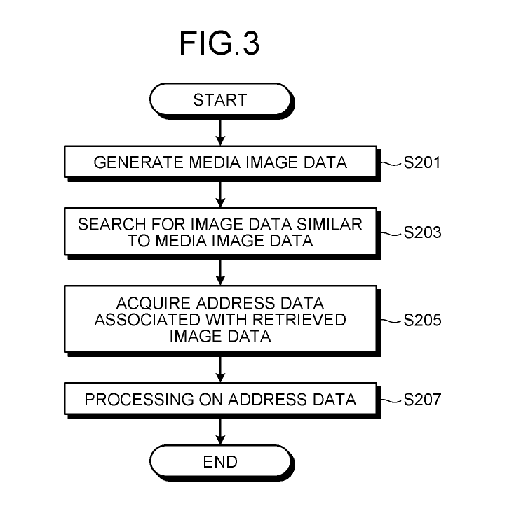

FIG. 3 is a flowchart illustrating an example of the procedure flow of searching processing implemented by the management system 1 according to the embodiment.

According to a searching instruction input by a user through an input device (not illustrated) of the image forming device 30, the reader 37 reads the printed medium and generates media image data (Step S201).

The searching unit 39 searches the second storage 33 for image data in which the degree of similarity with the media image data generated by the reader 37 is equal to or greater than a threshold (Step S203), and acquires address data associated with the image data (Step S205).

The processor 41 performs processing based on the address data acquired by the searching unit 39 (Step S207).

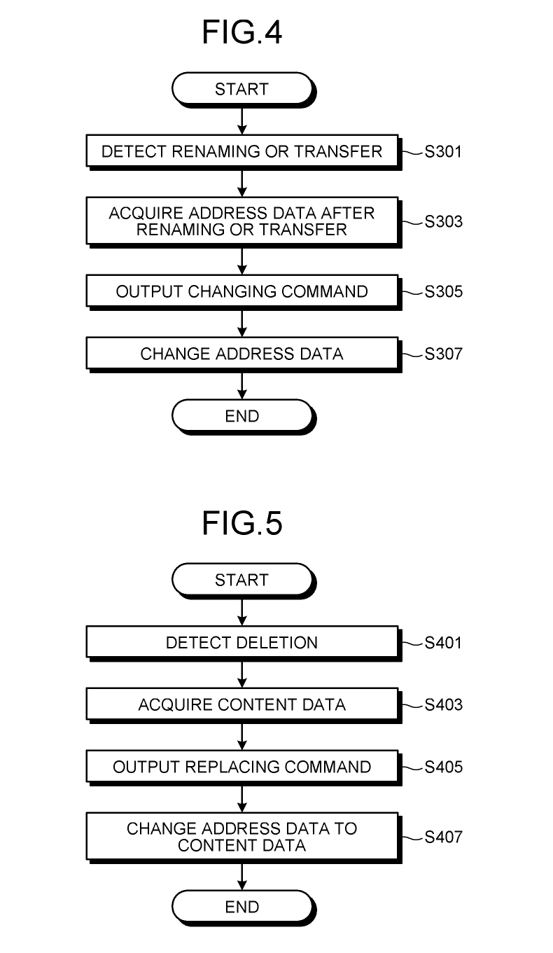

FIG. 4 is a flowchart illustrating an example of the procedure flow of address data updating processing implemented by the management system 1 according to the embodiment.

The changing unit 23 monitors the operation of a user on the content data stored in the first storage 11 as a monitored object. When detecting a renaming or transferring operation (Step S301), the changing unit 23 acquires address data before the renaming or transferring operation and address data after the renaming or transferring operation from the first storage 11 (Step S303).

The changing unit 23 thereafter outputs an address changing command (address updating command) including the address data before the renaming or transferring operation and the address data after the renaming or transferring operation to the second storage 33 (Step S305), and changes (updates) address data of the content data as an monitored object, the address data coinciding with the address data before the renaming or transferring operation and stored in the second storage 33, to the address data after the renaming or transferring operation (Step S307).

FIG. 5 is a flowchart illustrating an example of the procedure flow of address data replacing processing implemented by the management system 1 according to the embodiment.

The changing unit 23 monitors the operation of a user on the content data stored in the first storage 11 as a monitored object. When detecting a deleting operation (Step S401), the changing unit 23 acquires address data before the deleting operation and the content data as a monitored object from the first storage 11 (Step S403).

The changing unit 23 thereafter outputs an address replacing command including the address data before the deleting operation and the content data to the second storage 33 (Step S405), and changes/replaces address data of the content data as a monitored object, the address data coinciding with the address data before the deleting operation and stored in the second storage 33, to/with the content data (Step S407).

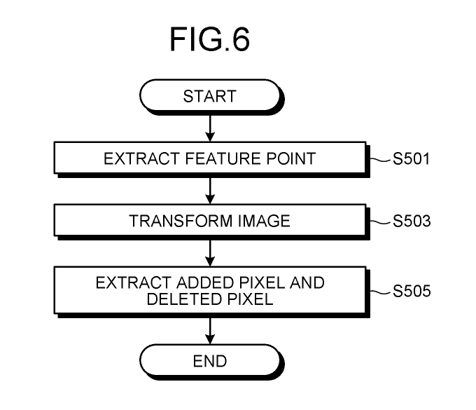

FIG. 6 is a flowchart illustrating an example of the procedure flow of additional data extracting processing implemented by the management system 1 according to the embodiment.

The processor 41 extracts an image feature point from each of the media image data (query data) and the image data (tag data) retrieved by the searching unit 39 (Step S501). At this time, it is preferable that the processor 41 extract a larger number of precise image feature points than that extracted by the searching unit 39 so as to keep the image resolution of the media image data (query data) and the image data (tag data) high. The calculation cost for the search of the searching unit 39 can be saved by lowering image resolution of both images to reduce the number of feature points.

The processor 41 associates the respective image feature points extracted from the media image data (query data) and the image data (tag data) with each other, and estimates the transformation matrix for transforming the coordinates of the media image data (query data) with the least square error so that the image feature point on the media image data (query data) comes to the same position as the corresponding image feature point on the image data (tag data). The processor 41 thereafter generates media image data with its coordinates transformed so that the media image data (query data) overlap the image data (tag data) (Step S503).

The processor 41 calculates the difference between the media image data (query data) and the image data (tag data) after the coordinate transformation, and extracts at least one of an added pixel and a deleted pixel, which exist on one data but does not exist on the other (Step S505). At this time, it is preferable that the processor 41 calculate the difference between binary images obtained by binarizing both images so as to be less affected by the difference in the luminance level of both images.

The additional data are extracted in this way. The additional data include an added pixel that exists on the media image data (query data) but does not exist on the image data (tag data) and a deleted pixel that exists on the image data (tag data) but is not found on the media image data (query data). Data with an added pixel and data with a deleted pixel are collectively referred to as additional data. The additional data may include at least coordinate values of the added pixel and the deleted pixel. The embodiment describes an example of extracting an image feature point from the image data (tag data) retrieved by the searching unit 39. In another way, an image feature point extracted in advance from the image data (tag data) may be stored in the second storage 33 and used for an extraction of the additional data.

According to the embodiment, the tag data are stored in printing. It is thus possible to save the cost to a user by reducing load on the user and correctly construct data to be managed. Furthermore, in the embodiment, not content data themselves but address data of the content data are stored. This can reduce required memory capacity, and thus save the cost.

The terminal device 20 of the embodiment only needs to output address data of content data instead of the content data themselves. This results in a reduction in the amount of communication traffic to the image forming device 30, and thus prevents the reduction in the productivity of producing a printed material due to the delay of communication is thus prevented. The amount of communication traffic to the image forming device 30 is further reduced with the increasing number of the terminal devices 20 that perform printing with the image forming device 30. This prevents the reduction in the productivity of producing a printed material due to the delay of communication.

According to the embodiment, when any change (such as renaming, a transfer, and a deletion) occurs on the content data stored in the first storage 11, address data, being stored in the second storage 33, of the content data are changed according to the change. This enables access to the content data after the change.

Modification 1

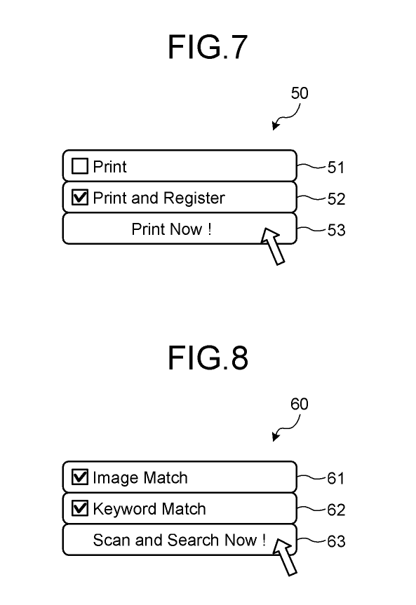

In the embodiment, a printing instruction input by a user through an input device (not illustrated) of the terminal device 20 may include a first instruction indicating registration or no registration. For example, a registration setting screen 50 as illustrated in FIG. 7 may be displayed on a display device (not illustrated) of the terminal device 20. When Print 51 is set through an input device (not illustrated) and a Print Now! button 53 is selected, the printing instruction may include the first instruction indicating no registration. When Print and Register 52 is set and the Print Now! button 53 is selected, the printing instruction may include the first instruction indicating registration.

When the first instruction indicates registration, the first generator 21 acquires address data together with content data from the first storage 11, generates a drawing command, and outputs the drawing command and the address data to the image forming device 30. The second storage 33 stores therein tag data based on the drawing command and the address data in association with each other.

When the first instruction indicates no registration, the first generator 21 acquires content data from the first storage 11, generates a drawing command, and outputs the drawing command to the image forming device 30. The second storage 33, however, does not stores therein tag data based on the drawing command or address data.

In this way, a user can select whether to construct data.

Modification 2

In the embodiment, image data and first-letter data of a first letter included in the image data may be used as tag data, and media image data and second-letter data of a second letter included in the media image data may be used as query data.

The first-letter data are extracted with the second generator 31 performing a morphological analysis on a drawing command. The second-letter data are extracted with the searching unit 39 implementing the optical character reader (OCR) processing on the media image data.

A searching instruction input by a user through an input device (not illustrated) of the image forming device 30 may include a second instruction indicating image or letter. For example, an image or letter setting screen 60 as illustrated in FIG. 8 is displayed on a display device (not illustrated) of the image forming device 30. When Image Match 61 is set through an input device (not illustrated) and a Scan and Search Now! button 63 is selected, the searching instruction may include the second instruction indicating image. When Keyword Match 62 is set and the Scan and Search Now! button 63 is selected, the searching instruction may include the second instruction indicating letter.

When the second instruction indicates image, the searching unit 39 searches the second storage 33 for image data in which the degree of similarity with the media image data is equal to or greater than a threshold and acquires address data associated with the image data.

When the second instruction indicates letter, the searching unit 39 searches the second storage 33 for the first-letter data in which the degree of similarity with the second-letter data is equal to or greater than a threshold and acquires address data associated with the first-letter data.

In this way, a user can select image or letter by which to search.

Modification 3

If the content data stored in the first storage 11 in the embodiment cannot be edited freely by a user (such as content on the web in which no authority for editing is allowed for a user), the changing unit 23 cannot monitor the content data stored in the first storage 11.

In this case, the changing unit 23 may regularly access the content data with address data stored in the second storage 33. If the content data are inaccessible, the changing unit 23 may output an address invalidation command invalidating the address data to the second storage 33 and invalidate the address data.

Modification 4

The second storage 33 in the embodiment may store therein content data in addition to tag data and address data. This enables access to the content data even if the content data stored in the first storage 11 cannot be edited freely by a user (such as content on the web in which no authority for editing is allowed for a user) and any change (such as renaming, a transfer, and a deletion) occurs on the content data.

Modification 5

The elements included in the management system 1 in the embodiment are replaceable as appropriate. For example, the second storage 33 may be provided outside the image forming device 30 in the manner of a network-attached storage (NAS) or the like. The terminal device 20 may include the reader 37. In this case, the reader 37 is implemented by an imaging device such as a camera. The terminal device 20 may include at least one of the first storage 11, the searching unit 39, and the processor 41. The image forming device 30 may include the changing unit 23.

Modification 6

The image forming device 30, content data, and a printed medium in the embodiment may be a three-dimensional printer, three-dimensional data, and a solid molding, respectively. In this case, the search is performed with tag data as multi-view image data of the solid molding generated in computer graphics and with query data as media image data imaging the solid molding (a printed medium). This enables access to the three-dimensional data based on which the solid molding is fabricated from the media image data imaging the solid molding output by the three-dimensional printer. In this case, it is preferable that the terminal device 20 include the reader 37 and the processor 41.

Hardware Configuration

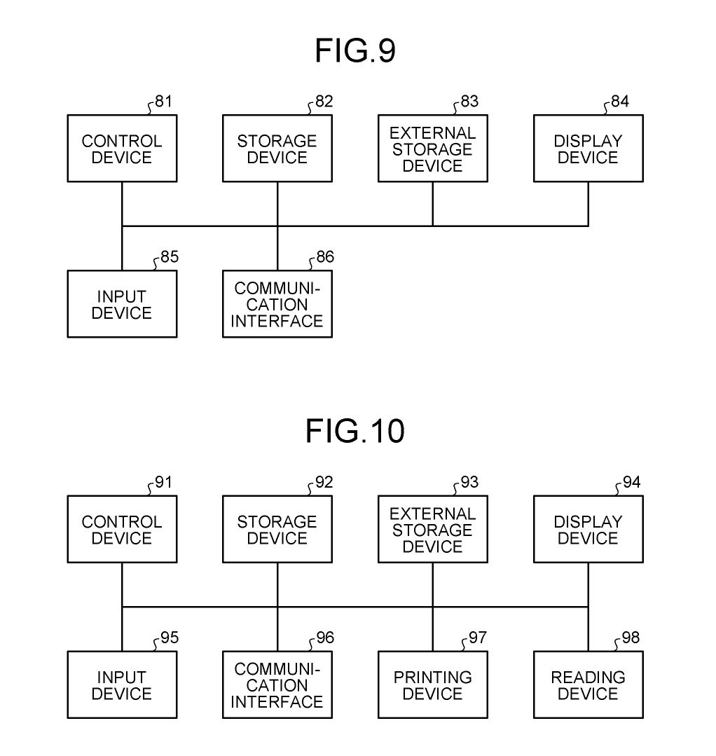

FIG. 9 is a block diagram illustrating an example of the hardware configuration of the terminal device 20 in the embodiment and the modifications. As illustrated in FIG. 9, the terminal device 20 of the embodiment and the modifications includes a control device 81 such as a CPU, a storage device 82 such as a read only memory (ROM) and a random access memory (RAM), an external storage device 83 such as an HDD and SSD, a display device 84 such as a display, an input device 85 such as a mouse and a keyboard, and a communication interface 86. The terminal device 20 is implemented by a hardware configuration using an ordinary computer.

The program executed by the terminal device 20 of the embodiment and the modifications is embedded and provided in a ROM and the like. In another way, the program executed by the terminal device 20 of the embodiment and the modifications may be stored and provided in a computer-readable memory medium such as a compact disc read only memory (CD-ROM), a compact disc recordable (CD-R), a memory card, a digital versatile disc (DVD), and a flexible disk (FD) as an installable or executable file. Furthermore, the program executed by the terminal device 20 of the embodiment and the modifications may be stored in a computer connected to a network such as the Internet and provided by being downloaded via the network.

The program executed by the terminal device 20 of the embodiment and the modifications has a module configuration to implement the above described units on a computer. As an example of the hardware, the control device 81 reads out the program from the external storage device 83 onto the storage device 82 and executes the program, whereby those units are implemented on a computer.

FIG. 10 is a block diagram illustrating an example of the hardware configuration of the image forming device 30 in the embodiment and the modifications. As illustrated in FIG. 10, the image forming device 30 of the embodiment and the modifications includes a control device 91 such as a CPU, a storage device 92 such as a ROM and RAM, an external storage device 93 such as an HDD and SSD, a display device 94 such as a display, an input device 95 such as a touch panel, a communication interface 96, a printing device 97 such as a printer, and a reading device 98 such as a scanner. The image forming device 30 is implemented by a hardware configuration using an ordinary computer.

The program executed by the image forming device 30 of the embodiment and the modifications is embedded and provided in a ROM or the like. In another way, the program executed by the image forming device 30 of the embodiment and the modifications may be stored and provided in a computer-readable memory medium such as a CD-ROM, a CD-R, a memory card, a DVD, and a flexible disc (FD) as an installable or executable file. Furthermore, the program executed by the image forming device 30 of the embodiment and the modifications may be stored in a computer connected to a network such as the Internet and provided by being downloaded via the network.

The program executed by the image forming device 30 of the embodiment and the modifications has a module configuration to implement the above described units on a computer. As an example of the hardware, the control device 91 reads out the program from the external storage device 93 onto the storage device 92 and executes the program, whereby those units are implemented on a computer.

As already described, the embodiment and the modifications achieve correct construction of data to be managed with a saved cost.

The steps in each of the flowcharts of the embodiment may be carried out in a changed order, in a manner that a plurality of steps are simultaneously carried out, or in a different order on every operation without departing from the properties of the steps.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A management system comprising:
first storage configured to store content data;
a first generator configured to acquire the content data and address data where the content data is stored, from the first storage, and generate a drawing command for printing the content data;
a second generator configured to generate image data of the content data according to the drawing command;
a second storage configured to store the address data and tag data based on the image data in association with each other; and
a printer configured to generate a printed medium by printing the image data on a medium.

2. The system according to claim 1, further comprising:
a changing controller configured to monitor the content data stored in the first storage, and to change, in response to a change on the content data, the address data of the content data stored in the second storage in accordance with the change.

3. The system according to claim 2, wherein the changing controller is configured to, when the change indicates a renaming that changes a name of the content data or a transfer that changes the area where the content data is stored in the first storage, acquire address data where the content data is stored after the renaming or the transfer, and change an address data of the content data stored in the second storage to the acquired address data.

4. The system according to claim 2, wherein the changing controller is configured to, when the change indicates a deletion of the content data, acquire the content data from the first storage before the deletion of the content data, and change the address data of the content data stored in the second storage to the acquired content data.

5. The system according to claim 1, further comprising:
a reader configured to electrically read the printed medium to generate media image data;
a searching controller configured to search the second storage for tag data in which a degree of similarity with query data based on the media image data is equal to or greater than a threshold, and acquire address data associated with the tag data; and
a processor configured to perform processing based on the address data acquired by the searching controller.

6. The system according to claim 5, wherein
the tag data comprises the image data,
the query data comprises the media image data, and
the processor is configured to further perform processing based on the media image data and the image data retrieved by the searching controller.

7. The system according to claim 6, wherein the processor is configured to extract, from the media image data, additional data in the media image data by referring to the image data retrieved by the searching controller, and store the additional data in the first storage in association with the content data using the address data.

8. The system according to claim 6, wherein the processor is configured to extract, from the media image data, additional data in the media image data by referring to the image data retrieved by the searching controller, acquire the content data from the first storage using the address data, and output the content data and the additional data.

9. The system according to claim 6, wherein the processor is configured to extract, from the media image data, additional data in the media image data by referring to the image data retrieved by the searching controller, acquire the content data from the first storage using the address data, generate additional content data by adding the additional data to the acquired content data, and store the additional content data in the first storage.

10. The system according to claim 6, wherein the processor is configured to extract, from the media image data, additional data in the media image data by referring to the image data retrieved by the searching controller, acquire the content data from the first storage using the address data, generate additional content data by adding the additional data to the acquired content data, and output the additional content data.

11. The system according to claim 1, wherein
the first generator is configured to, when a first instruction indicates registration, acquire, from the first storage, the content data and the address data where the content data is stored and generate a drawing command for printing the content data, and
the second storage is configured to store the tag data and the address data in association with each other when the first instruction indicates registration.

12. The system according to claim 11, wherein
the first generator is configured to acquire the content data from the first storage and generate a drawing command for printing the content data when the first instruction indicates no registration, and
the second storage is configured not to store the tag data or the address data when the first instruction indicates no registration.

13. The system according to claim 5, wherein
the tag data includes the image data and first-letter data of a first letter included in the image data,
the query data includes the media image data and second-letter data of a second letter included in the media image data, and
the searching controller is configured to, when a second instruction indicates image, search the second storage for image data in which a degree of similarity with the media image data is equal to or greater than a threshold, and acquire address data associated with the image data.

14. The system according to claim 5, wherein
the tag data comprises the image data and first-letter data of a first letter in the image data,
the query data comprises the media image data and second-letter data of a second letter in the media image data, and
the searching controller is configured to, when a second instruction comprises letter, search the second storage for the first-letter data in which a degree of similarity with the second-letter data is equal to or greater than a threshold, and acquire address data associated with the first-letter data.

15. An image forming device comprising:
a generator configured to receive a drawing command for printing content data stored in a storage device, and address data where the content data is stored in the storage device, and generate image data of the content data according to the drawing command;
storage configured to store the address data and tag data based on the image data in association with each other; and
a printer configured to print the image data on a medium and generate a printed medium.

16. A terminal device comprising:
a generator configured to acquire, from a storage device, content data and address data where the content data is stored, generate a drawing command for printing the content data, and output the drawing command and the address data to an external device that manages the address data and tag data based on the drawing command in association with each other.
